(19) United States
(12) Patent Application Publication
(10) Pub. No.: US 2017/0126969 A1
(43) Pub. Date: May 4, 2017

(54) IMAGE SHOOTING MODULE AND SYSTEM THEREOF

(71) Applicant: Chia-Jung Lee, Taipei City (TW)

(72) Inventor: Chia-Jung Lee, Taipei City (TW)

(21) Appl. No.: 14/931,856

(22) Filed: Nov. 4, 2015

(51) Int. Cl. H04N 5/232; H04N 1/00; H04N 5/247

(52) U.S. Cl. CPC H04N 5/23238; H04N 5/247; H04N 5/23206; H04N 5/23216; H04N 1/00244; H04N 1/00103; H04N 1/00119

(57) ABSTRACT

An image shooting system includes a plurality of image shooting modules, each of which has a lens device connected to a mobile device. The mobile device has an application unit, which interprets the location of the lens device connected thereto according to position data generated by the lens device. The application unit acquires position data of other image shooting modules via a communication platform, and includes other lens devices in the same area into a collaborative group to collaboratively shoot.

### FIELD OF THE INVENTION

The present invention relates to an image shooting system, and more specifically, to a plurality of image shooting modules and a system thereof that can collaboratively shoot images via collaborative groups.

### BACKGROUND OF THE INVENTION

Currently, the shooting angle is dependant on personal decision and control. Such a personal and individual shooting style shows isolated and cannot be successfully integrated into the surrounding environment. Also, many personal shooting angles are highly overlapped image-taking method to cause the almost same look. Individual image-taker works alone to cause double-work condition and wastes sources.

Also, due to the personal or individual shooting style, there are two ways to take a partially surrounding image or a panoramic image: the first one is that individual stand with a camera, and horizontally rotates the camera a circle to take the panoramic image, then to process with software. The second way is using a multi-lens camera to shoot synchronizedly.

However, in the first case involves personal shooting angles are highly overlapped image-taking method to cause the almost same look, and the second case is costly and heavy, which is apt to cause some problems, such as consume more power.

### SUMMARY OF THE INVENTION

To solve the above problems, a primary object of the present invention is to provide an image shooting system that shoots images with collaborative groups not individual shooting.

Another object of the present invention is to provide an image shooting system that includes a plurality of individual lens devices which are able to actively adjust their own shooting angle in real time through social network according to their own position data.

A further object of the present invention is to provide an image shooting system that is capable of adjusting each shooting angle of individual lens devices thereof according to position data along with relative data generated by individual lens devices.

A still further object of the present invention is to provide an image shooting system that shoots and completes a panoramic image with a plurality of image shooting modules exchanging their own position data through social network.

To achieve the above and other objects, the image shooting system provided according to the present invention includes a plurality of image shooting modules, each of which has a lens device. The lens device has a lens unit, a positioning unit, a processing unit, a rotation unit, and a wireless communication unit. The lens unit is used for shooting an image, which is processed into image data by the processing unit. The positioning unit generates position data, and the rotation unit rotates relative to the lens unit. A mobile device has an application unit, which is connected to the lens device via the wireless communication unit to acquire position data of the lens device, according to the position data, defines a predetermined area, and has a collaborative group. The application unit of each image shooting module acquires position data of the lens devices of other image shooting modules via a communication platform, and includes other lens devices in the predetermined area into the collaborative group to collaboratively shoot. The application unit further interprets each lens device's relative location in the collaborative group according to their individual position data to respectively control the rotation unit to rotate relative to and adjust the lens device of the lens unit, such that each lens device respectively shoots at different shooting angles.

In an embodiment, the positioning unit has a locator, and the position data is geographic data.

In an embodiment, the positioning unit has a locator and a relative position sensor, whereas the position data is geographic data.

In an embodiment, the relative position sensor includes an ultrasonic sensor, a light sensor, a Bluetooth sensor, or any combination thereof.

In an embodiment, the rotation unit is a servo motor that can rotate by 360 degrees.

In an embodiment, the communication platform is a cloud server.

In an embodiment, the lens device further includes a mike unit for receiving an environmental sound, which is processed into sound data by the processing unit.

In an embodiment, the positioning unit further includes a weight sensor for sensing the lens unit slant angle; the lens unit has a slant angle adjustment unit, which adjusts the slant angle of the lens unit according to the data sensed by the weight sensor.

With these arrangements, the image shooting system has a plurality of image shooting modules, each of which has a lens device connected to a mobile device. The mobile device has an application unit, which interprets the location of the lens device connected thereto according to the position data generated by the lens device. Each image shooting module acquires position data of the lens device of other image shooting modules via a communication platform to include other lens devices in the same area into a collaborative group. The mobile device adjusts individual lens device to shoot at different shooting angles according to a relative position data generated by each lens device of the collaborative group.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a block diagram of a plurality of image shooting modules and a system thereof according to a preferred embodiment of the present invention;

FIG. 1B is a block diagram of an image shooting modules included in the image shooting module and system thereof according to the preferred embodiment of the present invention;

FIG. 1C is a block diagram of a lens device included in the image shooting module and system thereof according to the preferred embodiment of the present invention;

FIG. 2 is a block diagram of a locator included in the image shooting module and system thereof according to the preferred embodiment of the present invention;

FIG. 3A shows a first example of the operation of the image shooting modules and the system thereof according to the preferred embodiment of the present invention;

FIG. 3B is a block diagram showing the first example of the operation of the image shooting modules and the system thereof after lens devices being added to a collaborative group;

FIG. 3C shows a mobile device included in the first example of the operation of the image shooting modules and the system thereof according to the preferred embodiment of the present invention;

FIG. 3D shows the mobile device after being changed their positions of FIG. 3C;

FIG. 4A shows the mobile device included in a second example of the operation of the image shooting modules and the system thereof according to the preferred embodiment of the present invention;

FIG. 4B shows the mobile device after being changed their positions of FIG. 4A; and

FIG. 5 shows a third example of the operation of the image shooting modules and the system thereof according to the preferred embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

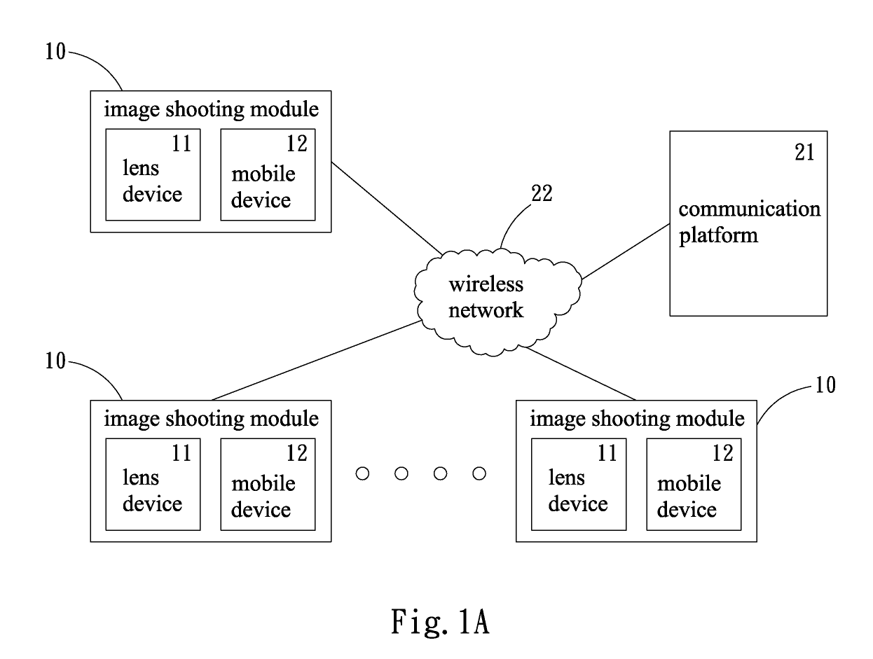

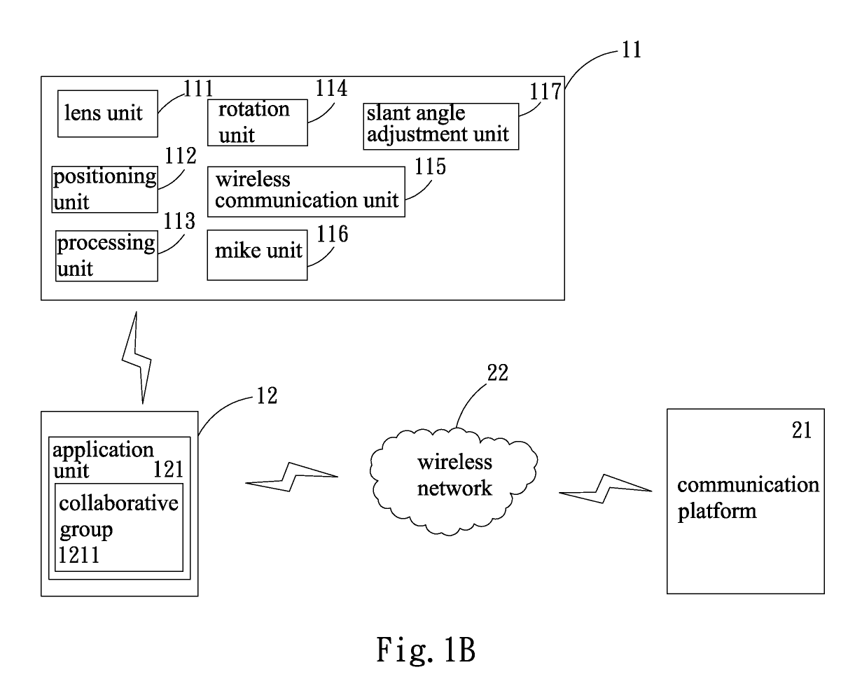

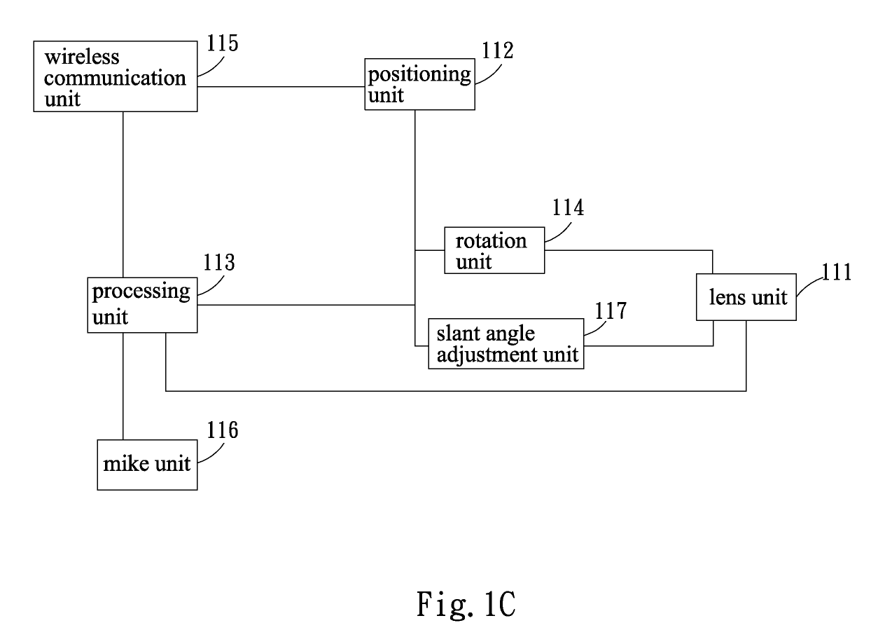

Please refer to FIG. 1A, which is a block diagram of a plurality of image shooting modules and a system thereof according to a preferred embodiment of the present invention. As shown, the image shooting system includes a plurality of image shooting modules 10, each of which has a lens device 11 connected to a mobile device 12. The mobile device 12 interprets the location of the lens device 11 connected thereto according to position data generated by the lens device 11. Each image shooting module 10 uploads and acquires position data of other image shooting modules 10 via a communication platform 21, such as a cloud server, and includes other lens devices 11 in the same area into a collaborative group 1211, such that each lens device 11 respectively shoots at different shooting angles.

Please refer to FIG. 1B, which is a block diagram showing connective relation between the lens device 11 and the mobile device 12 of the present invention, to FIG. 1C, which is a block diagram of the lens device 11 included in the image shooting module 10 and system thereof according to the preferred embodiment of the present invention, along with FIG. 1A. As shown, the lens device 11 of the image shooting module 10 includes a lens unit 111, a positioning unit 112, a processing unit 113, a rotation unit 114, and a wireless communication unit 115. The lens unit 111 is connected to the processing unit 113, whereas the positioning unit 112 is respectively connected to the rotation unit 114 and the processing unit 113. The rotation unit 114 is connected to the lens unit 11, and the wireless unit 115 is respectively connected to the positioning unit 112 and the processing unit 113.

The lens unit 111 is used for shooting an image, which is processed into image data by the processing unit 113. In an embodiment, the lens unit 111 has a plurality of lens for generating an imaging, and a visual angle, which can be ranged, for example but not limited to, 90 to 160 degrees, and preferably 120 degrees in the illustrated preferred embodiment. The processing unit 113 is used for receiving and processing the image shot by the lens unit 111. The positioning unit 112 is used for generating position data.

In an embodiment, the positioning unit 112 has a locator 1121 and a relative position sensor 1122. The locator 1121, such as a Global Positioning System (GPS), generates a geographic data according to satellite signal. The relative position sensor 1122, for example but not limited to, generates a sensing signal to transmit to other nearby lens devices 111, and either senses signals transmitted by other nearby lens devices 111 to generate relative position data, or transmits a sensing signal to other nearby lens devices 111 and then receives feedback signals transmitted by other nearby lens devices 111 to generate relative position data. The relative position sensor 1122 includes an ultrasonic sensor, a light sensor, a Bluetooth sensor, or any combination thereof. In another embodiment, the positioning unit 112 includes only a locator 1121.

The rotation unit 114 rotates relative to the lens unit 111. In an embodiment, the rotation unit 114 can be, for example but not limited to, a servo motor which can rotate by 360 degrees, and rotates relative to the lens device 111 in the same direction, such as in horizontal direction by 360 degrees. The wireless communication unit 15 can be, for example but not limited to, a WiFi communication unit or a Bluetooth communication unit to wirelessly connect other devices. The lens device 11 further includes a mike unit 116 for receiving an environmental sound, such as an environmental sound or a user's sound, which is processed into sound data by the processing unit 113. Normally speaking, after shooting, the lens device 11 generates an image combined with the sound data.

In another embodiment, the lens unit 111 further has a slant angle adjustment unit 117 connected to the positioning unit 112. The positioning unit 112 further includes a weight sensor 1123 for sensing the slant angle of lens unit 111. The slant angle adjustment unit 117 adjusts the slant angle of the lens unit 111 to upwardly or downwardly slant according to the data sensed and transmitted by the weight sensor 1123. The weight sensor 1123 can be, for example, a G-sensor, and the slant angle adjustment unit 117 can be, for example, a bidirectional motor device, and is able to adjust the lens unit 111 to, for example but not limited to, move ranged from upward 90 degrees to downward 30 degrees. Furthermore, when the lens unit 111 slant upwardly or downwardly, the weight sensor 1123 senses the slant angle of the lens unit 111 and then transmits the sensed data to the slant angle adjustment unit 117, such that according to the data sensed by the weight sensor 1123, the slant angle adjustment unit 117 is therefore able to adjust and keep the slant angle of the lens unit 111 at a horizontal position.

The mobile device 12 of the image shooting module 10 has an application unit 121, which is wirelessly connected to the lens device 11 via the wireless communication unit 115 to acquire position data of the lens device 11, according to the position data, defines a predetermined area. The predetermined area specifically is defined as a circle area, in which the connected lens device 11 serves as a center point and take a distance as a radius to draw a virtual circle. The radius can be determined according to users' number or users' location, and, for example but not limited to, 10-40 meters. Also, the application unit 121 of each mobile device 12 has a collaborative group 1211, and connected to the communication platform 21, such as a cloud server, via a wireless network 22 to acquire position data of the lens devices 11 of other image shooting modules 10 via the communication platform 21, and includes other lens devices 11 in the predetermined area into the collaborative group 1211. Each lens device 11 in the collaborative group 1121 senses relative position data among one another via the relative position sensor 1122 of the positioning unit 112. The application unit 121 of the mobile device 12 further interprets each lens device's relative position data in the collaborative group 1211 according to their individual position data to respectively control the rotation unit 114 of each lens device 11 to rotate relative to and adjust the lens device 11 of the lens unit 111, such that each lens device 11 respectively shoots at different shooting angles.

It should be noted here that the image data shot by each lens device 11 in the collaborative group 1121 collaboratively contain synchronized geographic, time, shooting angle information, and changed records of each lens device 11 during shooting.

Also, the image data which carry the information are uploaded from the application unit 121 of the connected mobile device 12 to a database of the communication platform 21, and then edited and reproduced by a render engine according to the geographic, time, shooting angle information of the image data, and changed records of each lens device 11 during shooting to further produce the whole image data after processed by the collaborative group 1211.

The application of the present invention will be described as follows, and for the purpose of easy to understand, elements that are included in the image shooting modules in the preferred embodiments are denoted by the reference numerals.

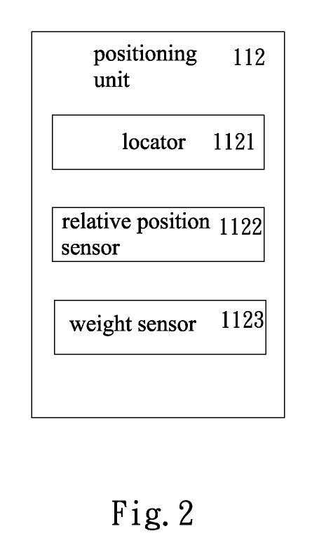

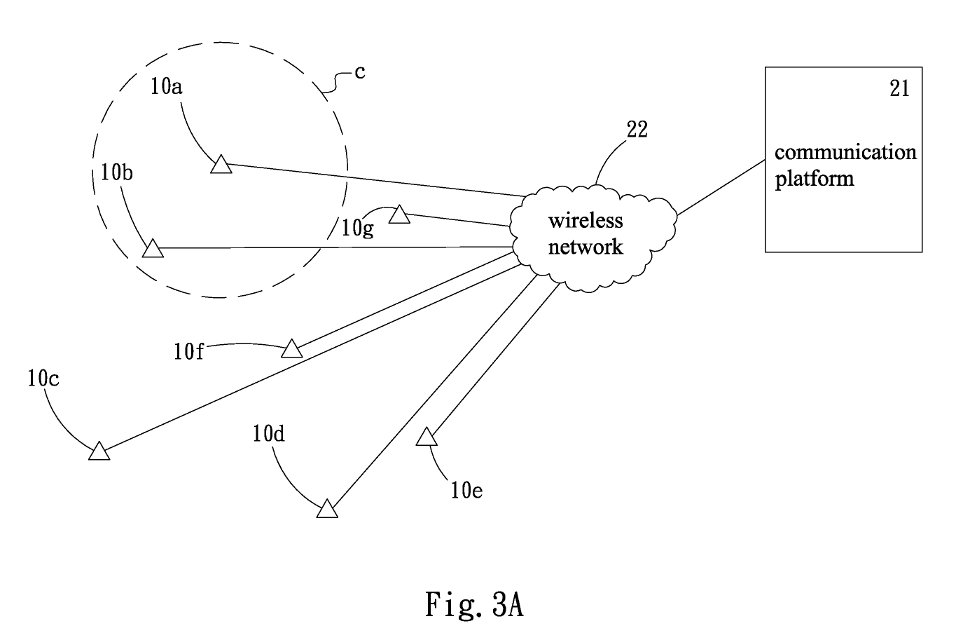

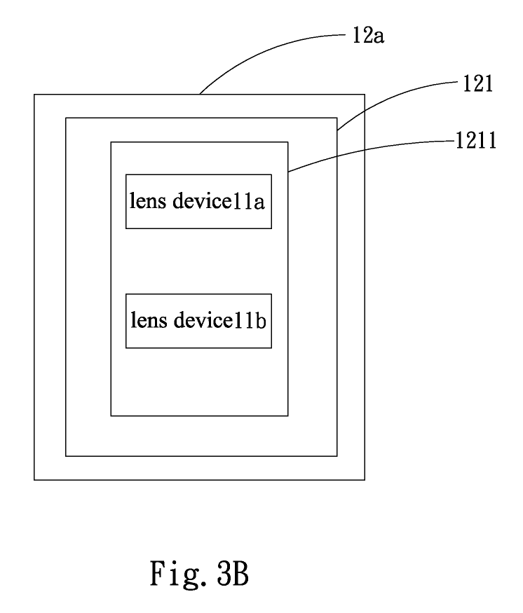

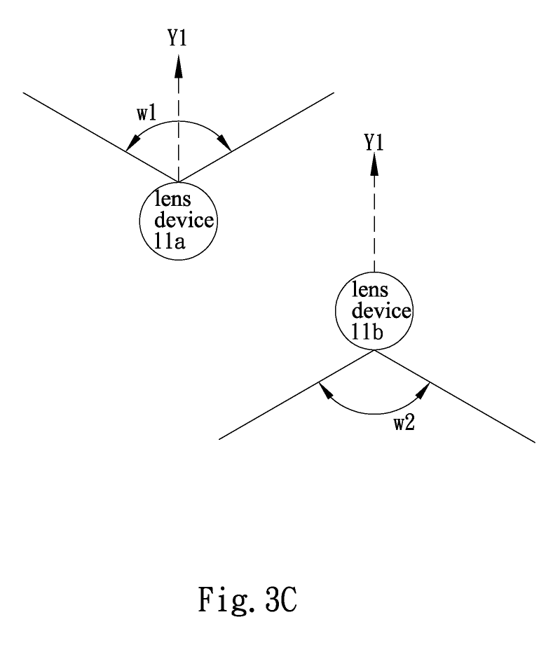

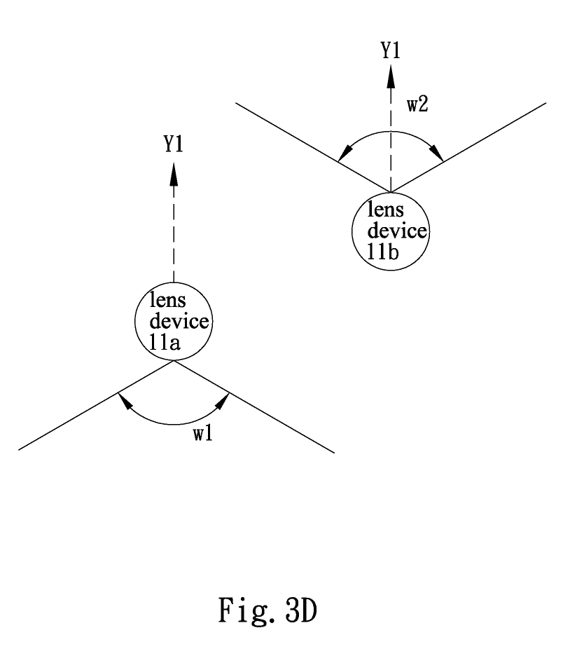

FIG. 3A shows a first example of the operation of the image shooting modules and the system thereof according to the preferred embodiment of the present invention, and FIG. 3B is a block diagram showing the first example of the operation of the image shooting modules and the system thereof after lens devices being added to a collaborative group, and FIG. 3C shows a mobile device included in the first example of the operation of the image shooting modules and the system thereof according to the preferred embodiment of the present invention, and FIG. 3D shows the mobile device after being changed their positions of FIG. 3C, as well as FIGS. 1A, 1B, and 2. As shown, a plurality of image shooting modules 10a-10g are connected to a communication platform 21, such as a cloud server, via a wireless network 22. For the purpose of conciseness, the image shooting module 10a is called a first image shooting module 10a, 10b a second image shooting module 10b, and the rest can be deduced by analogy. The mobile device 12a of the first image shooting module 10a is connected to the lens device 11a and acquires the position data of the lens device 11a to interpret the location of the lens device 11a and to define a predetermined area C according to the position data of the lens device 11a.

The application unit 121 of the mobile device 12a of the first image shooting module 10a acquires the position data of the lens devices 11a-11g of other image shooting modules 10b-10g, and according to there data, interprets the second image shooting module 10b located within the predetermined area C of the first image shooting module 10a. The application unit 121 of the mobile device 12a of the first image shooting module 10a includes the lens devices 11a, 11b in the collaborative group 1211, which respectively generate individual relative position data after sensing each other's relative position data.

As shown in FIG. 3C, the lens devices 11a, 11b in the collaborative group 1211 has a shooting main axis Y1, which is the direction the lens devices 11a, 11b in the collaborative group 1211 go forward. The application unit 121 of the mobile device 12a of the first image shooting module 10a interprets that the lens device 11a is in front of the lens device 11b according to the relative position data, and then controls the rotation unit 114 of the lens device 11a to forwardly rotate relative to the shooting angle w1 of the lens device 111, that is, to orient the same direction as the shooting main axis Y1.

As shown in FIG. 3D, when the relative positions of the lens devices 11a, 11b in the collaborative group 1211 are changed, the application unit 121 interprets the lens device 11a is behind the lens device 11b according to the relative position data, and then controls the rotation unit 114 of the lens device 11a to backwardly rotate relative to the shooting angle w2 of the lens device 111, that is, to orient the same direction as the shooting main axis Y1.

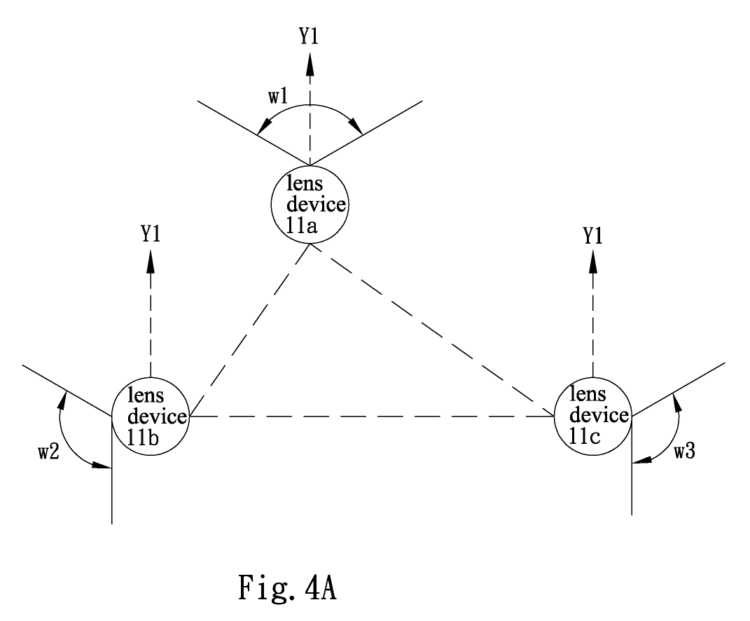

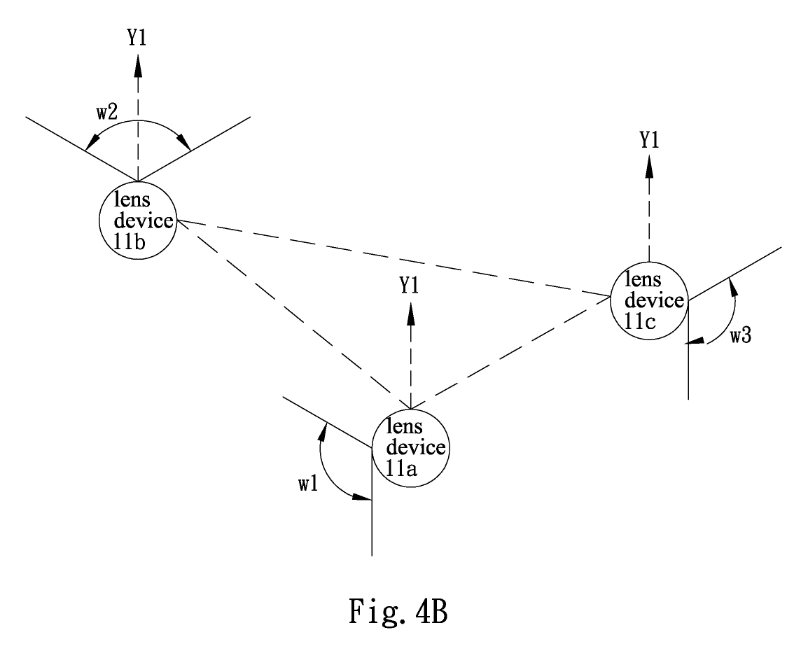

Please refer to FIG. 4A, which shows the mobile device included in a second example of the operation of the image shooting modules and the system thereof according to the preferred embodiment of the present invention, and FIG. 4B, which shows the mobile device after being changed their positions of FIG. 4A, along with FIGS. 1A, 1B, 2, and FIGS. 3A to 3D. In another embodiment, there are three lens devices in the collaborative group 1211, and they are lens devices 11a, 11b, and 11c. The application unit 121 of the mobile device 12a of the first image shooting module 10a interprets that the lens device 11a is in the forefront, the lens device 11b is at the left side of the lens device 11c, and the lens device 11c is at the right side of the lens device 11b, that is, the relative positions of the three lens devices 11a, 11b, and 11c together form a biggest triangle area. The shooting angle w1 of the lens device 11a orients forwardly, i.e. the same direction as the shooting main axis Y1, the shooting angle w2 of the lens device 11b orients in left-rear direction, i.e. 60 degrees from the left side of the shooting main axis Y1, and the shooting angle w3 of the lens device 11c orients in right-rear direction, i.e. 60 degrees from the right side of the shooting main axis Y1. Since the shooting angle w1, w2, and w3 of the three lens devices 11a, 11b, and 11c are respectively preferably 120 degrees, the union of the three lens devices 11a, 11b, and 11c creates a at least 360 degree panoramic image.

when the relative positions of the lens devices 11a, 11b, and 11c in the collaborative group 1211 are changed, the application unit 121 interprets that the lens device 11b is in the forefront, the lens device 11a is in the rearmost and at the left side of the lens device 11c, and the lens device 11c is at the right side of the lens device 11a, that is, the triangle formed by the relative positions of the three lens devices 11a, 11b, and 11c is changed. The shooting angle w2 of the lens device 11b orients forwardly, i.e. the same direction as the shooting main axis Y1, the shooting angle w1 of the lens device 11a orients in left-rear direction, i.e. 60 degrees from the left side of the shooting main axis Y1, and the shooting angle w3 of the lens device 11c orients in right-rear direction, i.e. 60 degrees from the right side of the shooting main axis Y1. Since the shooting angle w1, w2, and w3 of three lens devices 11a, 11b, and 11c are respectively preferably 120 degrees, the union of the three lens devices 11a, 11b, and 11c creates a at least 360 degree panoramic image.

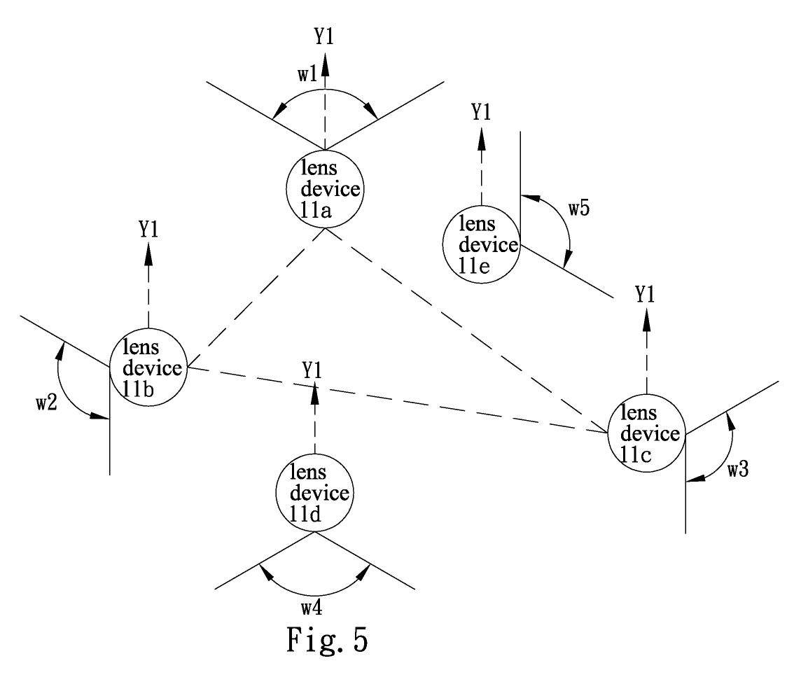

Please refer to FIG. 5, which shows a third example of the operation of the image shooting modules and the system thereof according to the preferred embodiment of the present invention, along with FIGS. 1A, 1B, 2, and FIGS. 3A to 3B and FIGS. 4A to 4B. In another possible embodiment, there are five lens devices in the collaborative group 1211, and they are lens devices 11a-11e. The application unit 121 of the mobile device 12a of the first image shooting module 10a interprets that the lens device 11a is in the forefront, the lens device 11b is at the leftmost, the lens device 11c is rightmost, and confirms the three lens devices 11a-11c together form a biggest triangle area. The application unit 121 of the mobile device 12a of the first image shooting module 10a interprets that the lens device 11d is between the lens device 11b and the lens device 11c, and in the rearmost, and lens device 11e is between the lens device 11a and lens device 11c, wherein the shooting angle w1 of the lens device 11a orients forwardly, i.e. the same direction as the shooting main axis Y1, the shooting angle w2 of the lens device 11b orients in left-rear direction, i.e. 60 degrees from the left side of the shooting main axis Y1, and the shooting angle w3 of the lens device 11c orients in right-rear direction, i.e. 60 degrees from the right side of the shooting main axis Y1. Since the shooting angle w1, w2, and w3 of the three lens devices 11a, 11b, and 11c are respectively preferably 120 degrees, the union of the three lens devices 11a, 11b, and 11c creates a at least 356 degree panoramic image. The shooting angle w5 of the lens device 11e is between the shooting angle w1 of the lens device w1 and the shooting angle w3 of the lens device 11c, whereas the shooting angle w4 of the lens device 11d is between the shooting angle w2 of the lens device 11b and the shooting angle w3 of the lens device 11c. That is, the forth and more lens devices is additional information to the panoramic image.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An image shooting module, comprising:
at least one lens device having a lens unit, a positioning unit, a processing unit, a rotation unit, and a wireless communication unit; the lens unit being used for shooting an image, which is processed into image data by the processing unit; the positioning unit generating position data; and the rotation unit being rotated relative to the lens unit.
at least one mobile device having an application unit, which is connected to the lens device via the wireless communication unit to acquire position data of the lens device and according to the position data defines a predetermined area, and has a collaborative group.
the application unit of each image shooting module being uploaded and acquired position data of the lens devices of other image shooting modules connected thereto via a communication platform, and being included other lens devices in the predetermined area into the collaborative group; and the application unit further being interpreted each lens device's relative location in the collaborative group according to their individual position data to respectively control the rotation unit to rotate relative to and adjust the lens device of the lens unit, such that each lens device respectively being shot at different shooting angles.

2. The image shooting module as claimed in claim 1, wherein the positioning unit has a locator, and the position data is geographic data.

3. The image shooting module as claimed in claim 1, wherein the positioning unit has a locator and a relative position sensor, whereas the position data is geographic data.

4. The image shooting module as claimed in claim 3, wherein the relative position sensor includes an ultrasonic sensor, a light sensor, a Bluetooth sensor, or any combination thereof.

5. The image shooting module as claimed in claim 3, wherein the positioning unit further includes a weight sensor for sensing the lens unit slant angle; and the lens unit having a slant angle adjustment unit, which adjusts the slant angle of the lens unit according to the data sensed by the weight sensor.

6. The image shooting module as claimed in claim 1, wherein the rotation unit is a servo motor that can rotate by 360 degrees.

7. The image shooting module as claimed in claim 1, wherein the communication platform is a cloud server.

8. The image shooting module as claimed in claim 1, wherein the lens device further includes a mike unit for receiving an environmental sound, which is processed into sound data by the processing unit.

9. An image shooting system, comprising:
a plurality of image shooting modules, each of which comprising:
a lens device having a lens unit, a positioning unit, a processing unit, a rotation unit, and a wireless communication unit; the lens unit being used for shooting an image, which is processed into image data by the processing unit; the positioning unit generating position data; and the rotation unit being rotated relative to the lens unit.
a mobile device having an application unit, which is connected to the lens device via the wireless communication unit to acquire position data of the lens device and according to the position data defines a predetermined area, and has a collaborative group.
the application unit of each image shooting module being uploaded and acquired position data of the lens devices of other image shooting modules connected thereto via a communication platform, and being included other lens devices in the predetermined area into the collaborative group; and the application unit further being interpreted each lens device's relative location in the collaborative group according to their individual position data to respectively control the rotation unit to rotate relative to and adjust the lens device of the lens unit, such that each lens device respectively being shot at different shooting angles.

10. The image shooting system as claimed in claim 9, wherein the positioning unit has a locator, and the position data is geographic data.

11. The image shooting system as claimed in claim 9, wherein the positioning unit has a locator and a relative position sensor, whereas the position data is geographic data.

12. The image shooting system as claimed in claim 11, wherein the relative position sensor includes an ultrasonic sensor, a light sensor, a Bluetooth sensor, or any combination thereof.

13. The image shooting system as claimed in claim 11, wherein the positioning unit further includes a weight sensor for sensing the lens unit slant angle; and the lens unit having a slant angle adjustment unit, which adjusts the slant angle of the lens unit according to the data sensed by the weight sensor.

14. The image shooting system as claimed in claim 9, wherein the rotation unit is a servo motor that can rotate by 360 degrees.

15. The image shooting system as claimed in claim 9, wherein the communication platform is a cloud server.

16. The image shooting system as claimed in claim 9, wherein the lens device further includes a mike unit for receiving an environmental sound, which is processed into sound data by the processing unit.
